(19) United States
(12) Patent Application Publication
(10) Pub. No.: US 2014/0122199 A1
(43) Pub. Date: May 1, 2014

(54) METHOD AND SYSTEM OF COLLECTING, STORING AND SHARING DIGITAL COUPONS, REBATES AND OFFERS UTILIZING A UNIFORM DATA FORMAT COMMUNICATED BETWEEN MULTIPLE PROVIDERS, PLATFORMS, AND PROVISIONING SYSTEMS

(71) Applicant: COUPON WALLET LLC, WASHINGTON TOWNSHIP, MI (US)

(72) Inventors: PHILIP J. KANABY, NEW HAVEN, MI (US); CHRISTOPHER A. PAPA, SHELBY TOWNSHIP, MI (US); SCOTT M. ADAMS, NEW BALTIMORE, MI (US)

(73) Assignee: COUPON WALLET LLC, WASHINGTON TOWNSHIP, MI (US)

(21) Appl. No.: 14/065,998

(22) Filed: Oct. 29, 2013

Related U.S. Application Data
(60) Provisional application No. 61/719,492, filed on Oct. 29, 2012.

(51) Int. Cl. G06Q 30/02

(52) U.S. Cl. CPC G06Q 30/0211
USPC 705/14.13

(57) ABSTRACT

A system and method for collecting storing, distributing and tracking digital coupons. The system and method include a platform/interface of a computing system for a plurality of businesses to submit digital coupons to a central coupon database of an application programming interface, and a platform/interface for consumers to create a user account with a user coupon database. The system and method further include a performance tracking database that stores information regarding coupons that are selected and redeemed by each user of the computing system.

### CROSS-REFERENCE TO RELATED APPLICATIONS

This application claims the benefit of the priority date of U.S. Provisional Patent Application Ser. No. 61/719,492, entitled METHOD AND SYSTEM OF COLLECTING, STORING AND SHARING DIGITAL COUPONS, REBATES AND OFFERS UTILIZING A UNIFORM DATA FORMAT COMMUNICATED BETWEEN MULTIPLE PROVIDERS, PLATFORMS, AND PROVISIONING SYSTEMS, filed Oct. 29, 2012.

### BACKGROUND OF THE INVENTION

1. Field of the Invention

This invention relates generally to digital coupons and, more particularly, to the collection, storage, distribution and tracking of digital coupons.

2. Discussion of the Related Art

Digital coupons are any discount offer that is available in electronic format, sometimes referred to as electronic coupons or e-coupons. Standard formats and conventions for digital coupons are currently sparse, putting unwanted strain on traditional brick-and-mortar businesses in terms of cost, distribution and redemption of these coupons. Changing formats in barcoding identification adds an additional layer of confusion when it comes to point of sale and the process of accepting the coupons. Furthermore, the lack of standards in digital coupons and couponing opens up avenues for fraud and limits the ability of manufacturers to offer digital coupons for their products. Thus, there is a need in the art for a simple and standardized digital coupon system that provides a bridge between traditional coupons and digital coupons to allow for the advancement of the digital couponing industry to integrate more successfully with traditional methods.

### SUMMARY OF THE INVENTION

In accordance with the teachings of the present invention, a system and method are disclosed for collecting storing, distributing and tracking digital coupons. The system and method include a platform/interface of a computing system for a plurality of businesses to submit digital coupons to a central coupon database of an application programming interface, and a platform/interface for consumers to create a user account with a user coupon database. The system and method further include a performance tracking database that stores information regarding coupons that are selected and redeemed by each user of the computing system.

Additional features of the present invention will become apparent from the following description and appended claims, taken in conjunction with the accompanying drawings.

### BRIEF DESCRIPTION OF THE DRAWINGS

FIG. 1 is a block diagram of a system for collecting, storing, distributing and tracking digital coupons;

FIG. 2 is a flow diagram of a process for accepting coupon data from businesses;

FIG. 3 is a flow diagram of various processes that may be used to collect coupon data;

FIG. 3a is an exemplary process for collecting coupon data and parameters;

FIG. 3b is another exemplary process for collecting coupon data and parameters;

FIG. 3c is another exemplary process for collecting coupon data and parameters;

FIG. 4 is a flow diagram of an exemplary process that describes how third party distribution and tracking of coupons may be achieved;

FIG. 5 is an illustration of potential ways that users may interact with marketing media containing digital coupons;

FIG. 6 is a flow diagram of a process that allows consumers to access coupons in a central coupon database;

FIG. 7 is an illustration of processes for allowing a user to redeem coupons that are in their user coupon database; and

FIG. 8 is a flow diagram of a process that provides various ways for a user to redeem coupons that are in their user coupon database.

### DETAILED DESCRIPTION OF THE EMBODIMENTS

The following discussion of the embodiments of the invention directed to a system and method for providing for the collection, storage, distribution and tracking of digital coupons is merely exemplary in nature, and is in no way intended to limit the invention or its applications or uses.

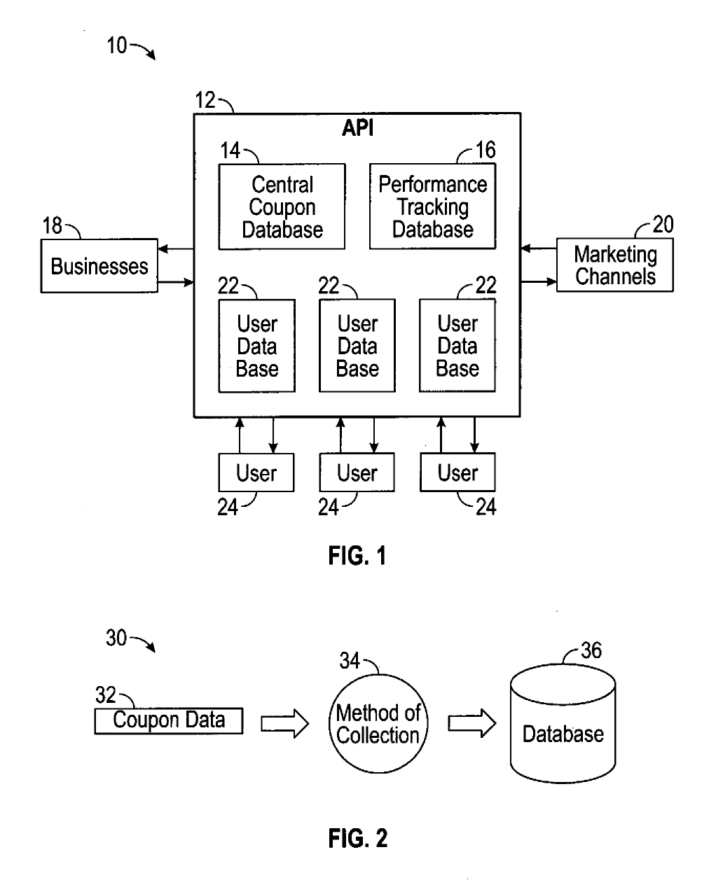

FIG. 1 is a block diagram of a system 10 for collecting, storing, distributing and tracking digital coupons. A server or applications/advanced programming interface (API) 12 is provided to interact with businesses and/or manufacturers 18, marketing channels 20 and users 24 as described in detail below. The API 12 includes a central coupon database 14 for storing coupons received from businesses 18, and user coupon databases 22 that include coupons from the central coupon database 14 that are selected by the users 24. Coupons that are included in the central coupon database 14 may also be advertised using the marketing channels 20 such that users 24 may select coupons that are in the central coupon database 14 via the marketing channels 20. Coupons that are selected and redeemed by users 24 are tracked by the performance tracking database 16 as is described in more detail below.

As stated above, a demand exists for a simple and standardized digital coupon system that provides a bridge between traditional and digital couponing. The term “digital coupon” as used herein includes any type of electronic coupon, rebate or offer. As is described in detail below, the coupon data is converted from their currently used format into a common format that can be stored in a centralized location, such as the server or application programming interface 12, and the coupon data may be accessed and distributed by a multiplicity of third parties, accessed by consumers, and stored in the user coupon database 22 for redemption at a point of sale. Furthermore, the coupons may be tracked, regulated, shared, duplicated, traded or repurposed as the business desires.

FIG. 2 is a flow diagram 30 that is a general overview of a process for accepting coupon data from a business or a manufacturer 18. At box 32, coupon data is received. Various methods for collecting coupon data are performed at box 34, and collected coupons are stored in the central coupon database 14 at box 36, as is described in more detail below. All methods require the submission of coupon information to a server application of the API 12. The coupon information required to create an entry in the central coupon database 14 will include a partner identifier and standard data elements such as those found on the majority of coupons and offers. A large number of optional data elements and behavior parameters may also be included to define how the coupon will be allowed to be stored, distributed, access and shared. Coupon parameters may change over time, e.g., face value of the coupon may change. Coupons may contain complex behaviors in which progressively better offers may be provided, this may include progressively better face value discounts, e.g., first use is $0.50 off, second use is $1.00 off, etc. This may also include a free product when the coupon is used n number of times, where the discount for face value remains the same until coupon is used n number of times at which point the nth use is 100% off. These are possible examples of how the coupon parameters may change dynamically based on utilization, although many other suitable dynamically changing coupon parameters may be used. The dynamic parameters discussed above are defined in the central coupon database 14 and changes, copied over to the user coupon database 22 in box 142, and when necessary user interactions are achieved, the user coupon database is updated to reflect the new coupon parameters.

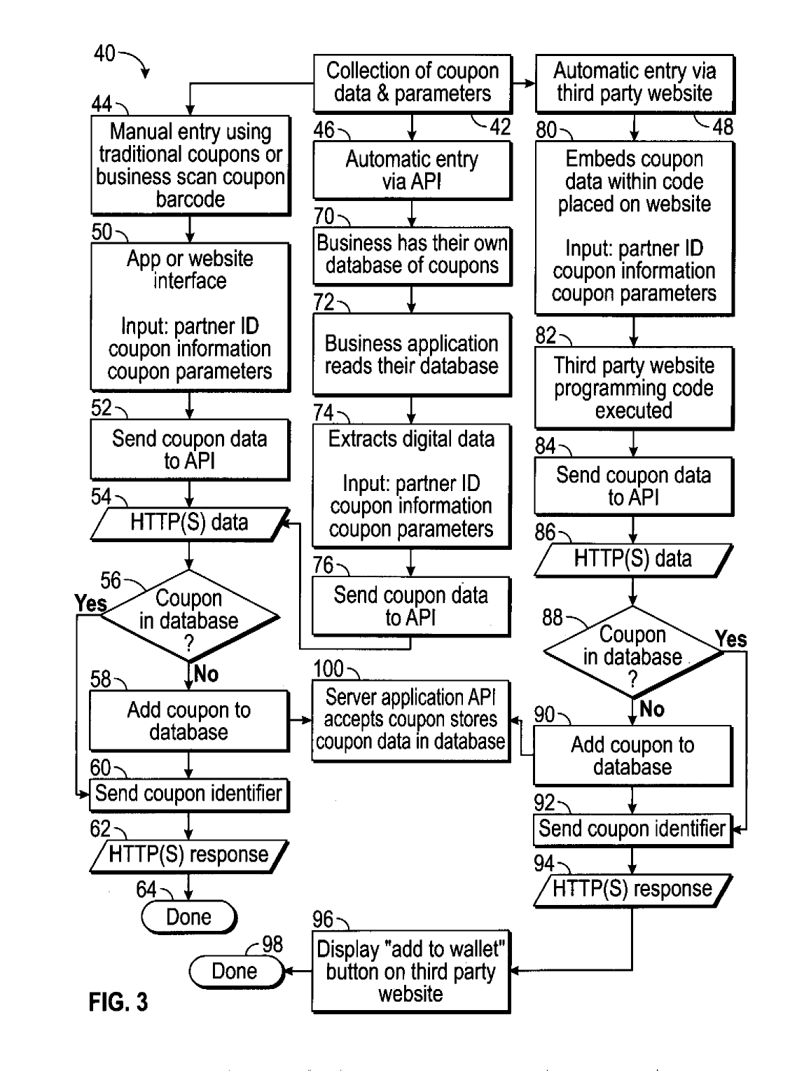

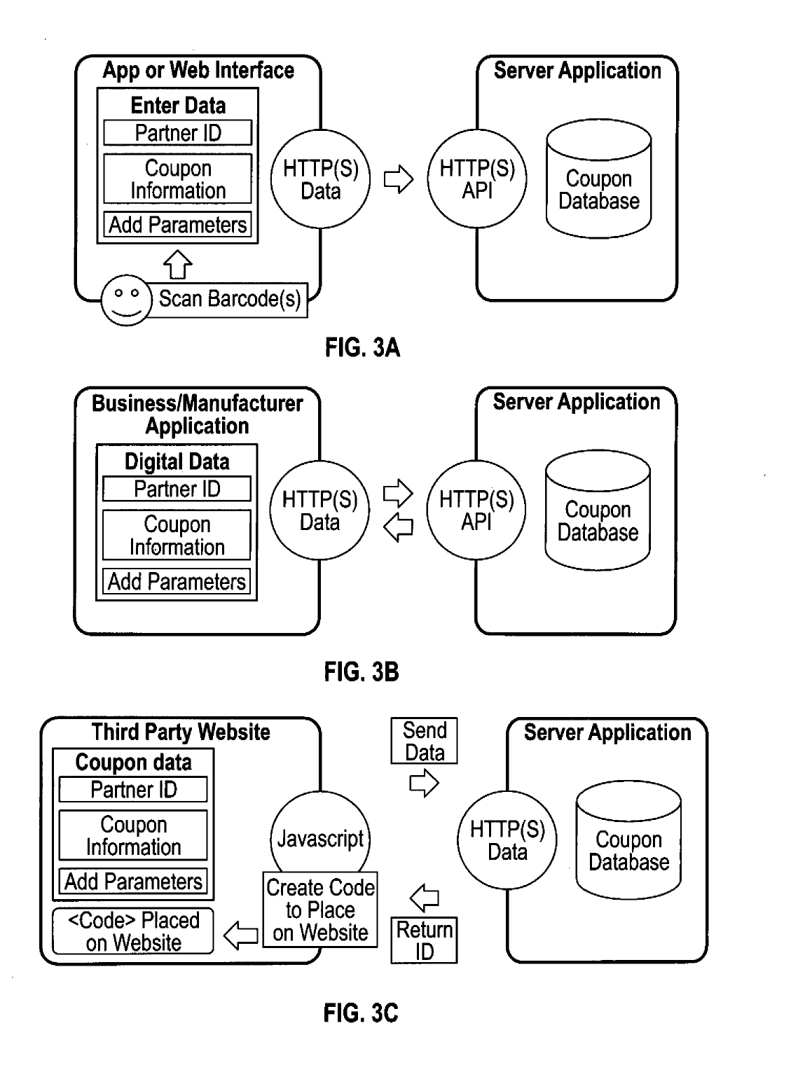

FIG. 3 is a flow diagram 40 that provides examples of various processes or algorithms that may be used to collect coupon data. At box 42 a request is received for the collection of coupon data and parameters. Boxes 44, 46 and 48 each begin a different process for collecting coupon data and parameters. At box 50, the coupon data and parameters are entered manually by the business 18 using traditional coupons, or the barcode of each coupon may be scanned using a scanning device in a known manner to avoid data entry mistakes. Scanning devices may include, but are not limited to, hardware barcode scanners, personal data devices, and/or handheld devices such as smart phones that are used by the business or manufacturer 18, or employees thereof. For example, using the API 12 via an interface such as a website interface, the business 18 may enter their partner identification that includes an access key that is provided to each business 18 at the time of signing up for an account with the system 10, along with coupon information, such as the product being discounted, and coupon parameters, e.g., expiration date, at box 50. Once all the data has been entered, the coupon data is sent to the API 12 at box 52. Once the coupon data is converted to HTTP(S) data at box 54, the data is transferred using an HTTP(S) protocol that is known in the art, and the data is received by the API 12. The process determines whether the coupon is already in the central coupon database 14 at decision diamond 56. If the coupon is not in the central coupon database 14 at the decision diamond 56, the coupon is added to the central coupon database 14 of the API 12 at box 58. Once the coupon is added to the central coupon database 14 at the box 58, or if the coupon is already in the database 14 as determined at the decision diamond 56, a coupon identifier is sent to the application or website interface (from the box 50) at box 60 through an HTTP(S) response at box 62. The process for collecting the coupon data is complete at box 64.

In another exemplary process beginning at the box 46, coupon data and parameters are automatically entered using the API 12. Using this approach, the business 18 utilizes their own database of coupons at box 70, and a business application created to utilize the API 12 reads the database of coupons of the business 18 at box 72 at predetermined times, which may be recurring. The business application extracts digital coupon data from the business database at box 74, which includes data such as partner ID, coupon information and coupon parameters. Coupon data is sent to the API 12 from the business database at box 76, and once the HTTP(S) data from the box 54 is received by the API 12, the algorithm proceeds as described above.

In another exemplary process beginning at the box 48, coupon data is automatically entered using any third party website desired, such as a website owned by the business 18, online coupon directories or social media websites. At box 80 coupon data is embedded into a piece of programming code provided to the business 18 to place on their own website. Next, third party website programming code such as Javascript is executed to allow businesses or manufacturers 18 to enter the digital coupon data from a website at box 82, and the coupon data is sent to the API 12 at box 84. The programming code provides the partner ID, access key and coupon data and parameters to the API 12. Once the HTTP(S) data from box 86 is received by the API 12, the process determines whether the coupon is already in the central coupon database 14 at decision diamond 88. If the coupon is not in the central coupon database 14 at the decision diamond 88, the coupon is added to the central coupon database 14 of the API 12 at box 90. Once the coupon is added to the database 14 at the box 90, or if the coupon is already in the central coupon database 14, as determined at the decision diamond 88, a coupon identifier is sent back to the website containing the programming code at box 92. After the coupon identifier is sent to the business 18 at the box 92 and an HTTP(S) response at box 94 is returned to the website, a display that reads, for example, “Add to Wallet” may be displayed on the third party website, indicating that the coupon is ready to be used. Thus, it is available for use by users 24, and also serves as an acknowledgment to the business 18 that their coupon is ready for use at box 96. After the display button is displayed at the box 96 the process is complete at box 98.

The returned response can place code onto the third party website that allows an interactive version of the digital coupon. The response can be in the form of a formatted coupon, a button, QR code, or other interactive visual formats of the digital coupon. Interaction with the digital coupon on the third party website can directly affect a user coupon database 22 in the API 12 as is described in more detail below.

Once the business's desired coupon or coupons have been added to the central coupon database 14 at the boxes 58 and 90, a server application of the API 12 accepts the coupon or coupons and stores the data and parameters in the central coupon database 14 at box 100. Each of the exemplary processes described in FIG. 3 for collecting coupon data and parameters that begin at the boxes 44, 46 and 48 are also depicted in FIGS. 3a, 3b and 3c. Once the coupon information has been entered into the central coupon database 14 and has been assigned a unique identifier, it is then ready for distribution. The distribution process can be handled both internally and externally with consumers finding coupons that are available within the API 12 and from outside sources as described in more detail below. Each unique coupon will be given a unique identifier which may be referenced in URLs, barcodes, QR codes, etc., and placed in various marketing channels 20 including, but not limited to, internet, mobile, print, video and radio. In the case of digital media, the distribution of the coupons may be controlled by the API 12 in order to follow the criteria defined in the coupon entry.

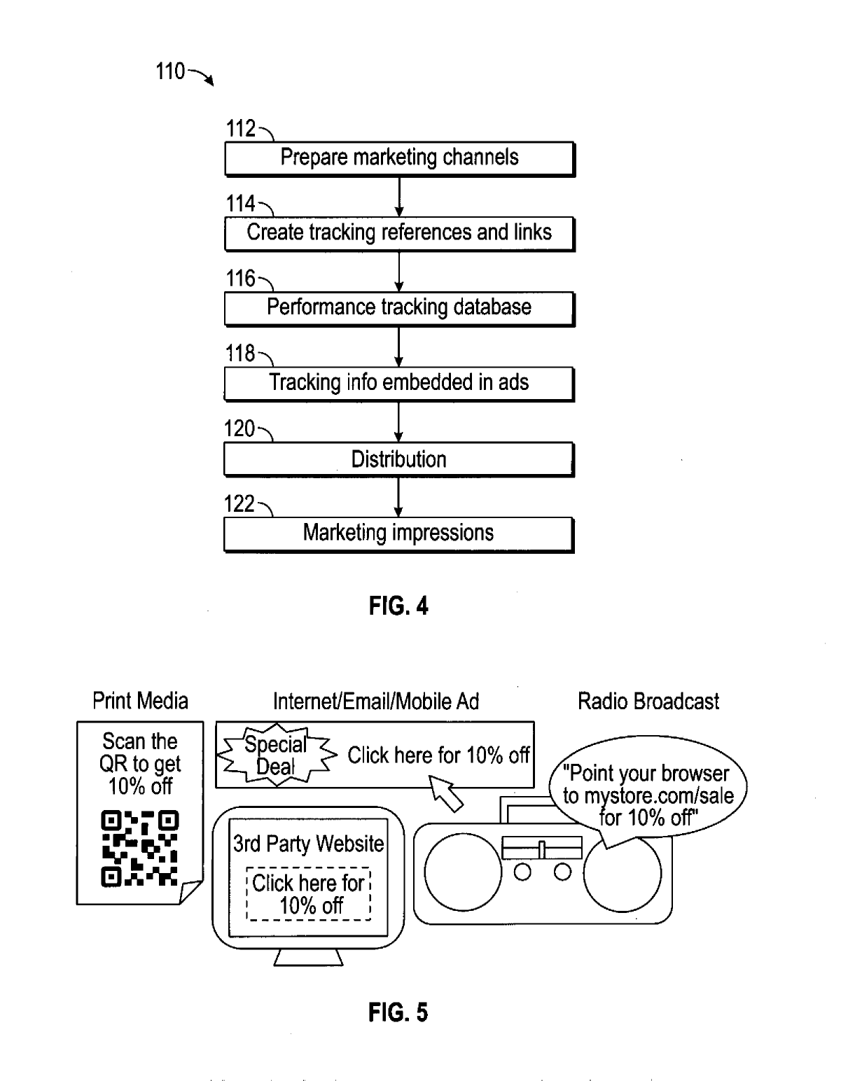

FIG. 4 is a flow diagram 110 of an exemplary process that describes how third party distribution of coupons that are in the central coupon database 14 may be achieved. At box 112, marketing channels 20 are prepared by receiving information from the business 18 that identifies each marketing channel through which digital coupons will be distributed. Tracking references and links are created automatically at box 114 for each identified channel in the performance tracking database 16 at box 116. Next, the tracking references and links are embedded into advertisements at box 118.

When presented with marketing media containing a digital coupon, consumers will have the opportunity to engage with the digital coupon and take action by adding the coupon to their user coupon database 22 in the API 12. FIG. 5 shows an illustration of some potential ways in which consumers may interact with marketing media containing digital coupons, as described in FIG. 4. The interaction of the consumer with the coupon can further be affected by the criteria contained in the coupon data. For example, if a coupon has a limited number of times it may be added by consumers, it may become unavailable when the limited supply runs out.

The coupons and their corresponding tracking information is distributed at box 120 using internal and external marketing efforts that may include, but are not limited to, in-store marketing, in-app advertising, coupon feeds, online marketing, television, radio and print marketing channels. This provides the benefit of coupon distribution at a much larger scale and accountability for results. Marketing impression information is collected at box 122, which includes, for example, how well each coupon is received, how many people use the coupon and the location of the coupon users. The action of storing the coupons on a per user basis helps to eliminate fraud while providing much greater tracking and data analysis opportunities. Also, analysis of the tracking data identifies how well each channel is performing, which consumers are using the digital coupons, what types of consumers are using the digital coupons, which digital coupons perform the best, and the audience that they perform the best with, or providing any valuable information regarding consumer shopping profiles.

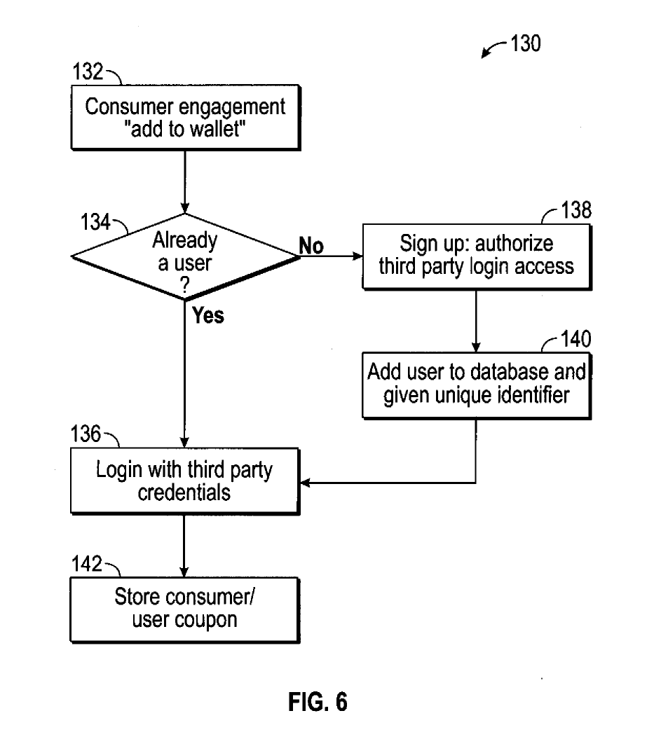

FIG. 6 is a flow diagram 130 of a process of how consumers are able to access coupons that are in the central coupon database 14. At box 132 an individual attempts to access a particular advertised coupon by interacting with URLs, barcodes, QR codes, etc., contained within marketing impressions at box 122 in any number of acceptable ways such as scanning a QR code or clicking a button on their computing device that reads, for example, “Add to Wallet”. The process determines if the consumer that is trying to add the coupon at the box 132 is already a user with access to the central coupon database 14 at decision diamond 134. If the consumer or user 24 already has access to the database 14 as determined by the decision diamond 134, the process prompts the user to log in using their unique credentials at box 136. If the process determines that the user 24 does not already have access to the database 14 at the decision diamond 134, the user 24 will be prompted to sign up to become authorized to have access to the central coupon database 14 at box 138. If the user 24 chooses to sign up at the box 138, the user 24 will be prompted to create an account or sign in using a third party account. Thereafter, the user is added to the user coupon database 22 and given a unique identifier at box 140, and will be logged in at box 136 as described above. When a new account is created, the user 24 information will be stored into a consumer database and a unique identifier will be assigned to the user 24.

Once the user 24 has logged in at the box 136, the user 24 is able to store the desired coupon or coupons that are in the central coupon database 14 in their own personal user database 22 of the API 12 at box 142, thereby making the coupon or coupons available for use and redemption as described below. Once the coupons are stored by each user 24 in their respective user coupon database 22, users are able to access and manage their stored coupons using various user interface platforms such as websites, applications, mobile devices, wearable devices, home entertainment systems, embedded systems, personal data storage devices, etc. These platforms may be created internally or by third party developers to operate on any system that is allowed to access the user coupon database 22 and thus provide the user 24 with easy access to their digital coupons. These platforms assist users 24 in organizing, browsing, viewing, deleting, sharing and redeeming their digital coupons.

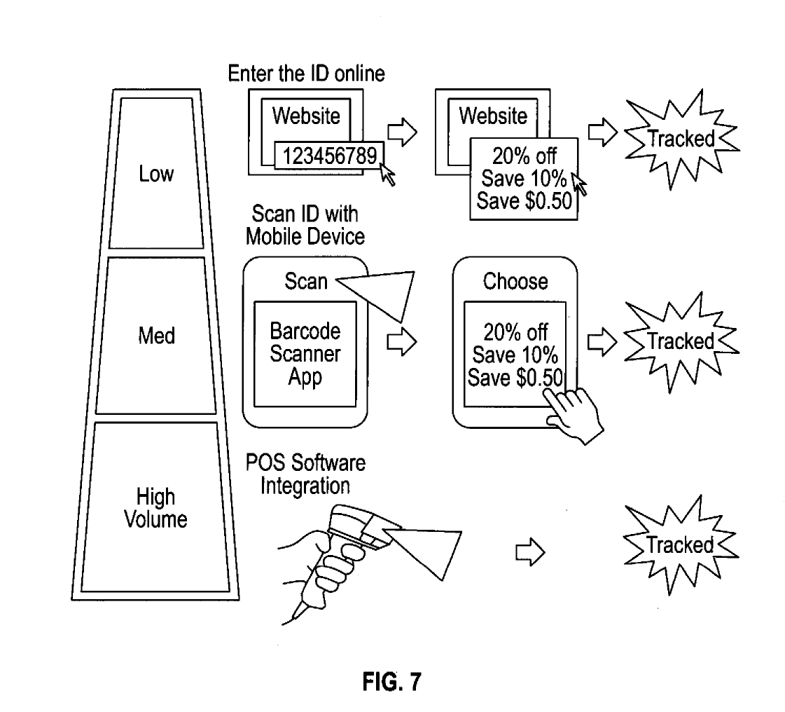

When it comes to redeeming coupons that are stored in a user coupon database 22, various methods may be implemented at the point of sale to verify, track and redeem the digital coupons, as is generally illustrated in FIG. 7. Each of the various methods locate the exact user coupon within the user coupon database 22 that the user 24 is attempting to use before the coupon can be tracked, redeemed and cleared from the user coupon database 22.

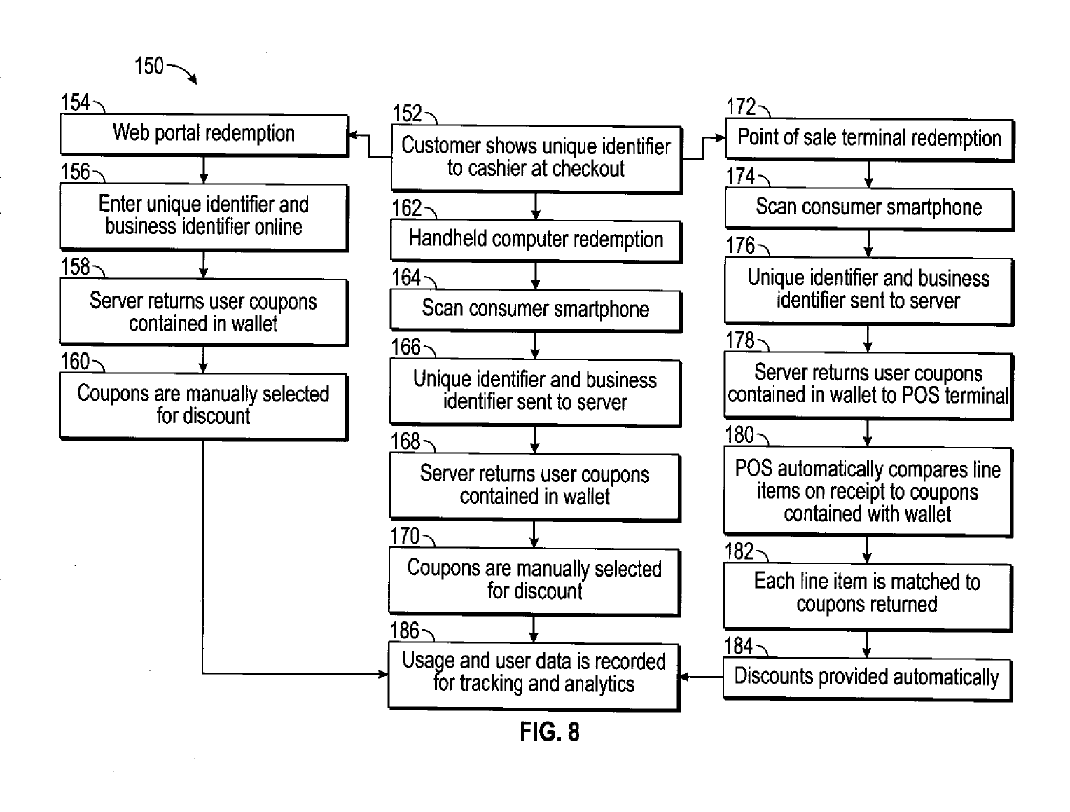

FIG. 8 is a flow diagram 150 that illustrates in greater detail various ways a registered user 24 of the API 12 may redeem coupons that are in their user coupon database 22. At box 152 the consumer or user 24 shows their unique identifier to a cashier at the time of checkout. This can be done by communicating the unique identifier directly to the point of sale, or by showing the unique identifier to a cashier via a handheld device that belongs to the user 24, such as a smart phone, so that the cashier may access the unique identifier using a point of sale hand held device or a scanner, as is described in more detail below.

In the example of a business 18 using a web portal to redeem a coupon or coupons, the process begins at box 154 when the cashier enters the user's unique identifier and a business identifier into some kind of internet enabled application or website interface online at box 156. At box 158, the API/server 12 returns the information that is contained in the user coupon database 22 that is associated with the unique identifier entered. Next, the cashier of the business 18 manually selects the coupons from the response returned at box 158 that the user 24 wishes to apply at checkout at box 160, and the sale proceeds such that the selected coupon or coupons are applied.

In another example, the process begins with a cashier that has a handheld scanning device at box 162. The cashier uses the handheld device to scan the user's unique identifier at box 164. The user's unique identifier and the business identifier is sent from the handheld device to the API/server 12 at box 166. The API/server 12 returns the applicable coupons that are contained in the user's coupon database 22 at box 168, and the coupons are manually selected by the cashier for discount at box 170.

In another example, the user 24 is at a point of sale terminal in a business and wishes to redeem coupons from their user coupon database 22 at box 172. To redeem the desired coupons, a user handheld device, such as the user's smart phone, is scanned by the cashier using a scanner or similar device at box 174. The user's unique identifier and the identifier of the business that the user 24 is checking out at is sent to the API/server 12 at box 176, and the server 12 returns the coupons that are in the user's coupon database 22 to the point of sale terminal at box 178. The point of sale terminal may then automatically compare line items on the receipt to coupons that are in the user's coupon database 22 at box 180. Line items that match coupons in the user's coupon database 22 are identified at box 182, and the appropriate discount is automatically applied at box 184. This approach is particularly useful for high volume businesses such as grocery stores.

Each time a user 24 redeems a coupon from their user coupon database 22, as is done in various ways described in FIG. 7 above, user data and coupon data is recorded for tracking and analytics at box 186. During the life cycle of digital coupons within the API/system 12, various tracking and analytic data will be collected and available to the creators of coupons and/or third parties to be used in appropriate marketing efforts to modify and optimize campaign parameters. The collection and distribution of such information will be limited based on applicable laws and regulations.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for collecting, storing, distributing and tracking digital coupons, rebates and offers, said method comprising:
providing an interface of a computing system for one or more businesses to submit digital coupons to a central coupon database of the computing system;
providing an interface of the computing system for consumers to create a user account that includes access to create a user coupon database;
providing marketing channels that communicate with the computing system such that when consumers respond to the marketing channel one or more coupons that are selected by the user are added to the user coupon database, said selected coupons being available for redemption after being added to the user coupon database; and
providing a performance tracking database of the computing system that stores information regarding coupons that are selected and redeemed by each user of the computing system.

2. The method according to claim 1 wherein the one or more businesses include businesses and manufacturers.

3. The method according to claim 1 wherein the one or more businesses are provided with a partner ID that allows the one or more businesses to submit digital coupons.

4. The method according to claim 1 wherein the one or more businesses may submit digital coupons by manually entering coupon data, by permitting the coupon system to search a business coupon database to find coupons to add to the central coupon database, or by automatically entering digital coupons using a third party website.

5. The method according to claim 1 wherein the marketing channels include in-store marketing, in-app advertising, coupon feeds, online marketing, television, radio and print marketing channels.

6. The method according to claim 1 wherein the user account allows users to browse, organize, view, delete, share and redeem their digital coupons using platforms such as websites, applications, mobile devices, wearable devices, home entertainment systems, embedded systems and personal data storage devices.

7. The method according to claim 1 wherein redemption of the digital coupon(s) includes presenting a unique identifier that is associated with the user to a cashier.

8. The method according to claim 7 wherein presenting the unique identifier to the cashier includes presenting a handheld device that belongs to the user and that contains the unique identifier to the cashier, said unique identifier providing the cashier access to the user's coupon database.

9. A method for collecting, storing, distribution and tracking digital coupons, rebates and offers, said method comprising:
providing an interface of a computing system for a plurality of businesses to submit digital coupons to a central coupon database of an application programming interface of the computing system;
providing an interface of the computing system for consumers to create a user account with a user coupon database, wherein the user is able to browse coupons in the central coupon database and add selected coupons from the central coupon database to the user coupon database, said selected coupons being available for redemption after being added to the user coupon database; and
providing a performance tracking database that stores information regarding coupons that are selected and redeemed by each user of the computing system.

10. The method according to claim 9 wherein the one or more businesses include businesses and manufacturers.

11. The method according to claim 9 wherein the one or more businesses are provided with a partner ID that allows the one or more businesses to submit digital coupons.

12. The method according to claim 9 wherein the one or more businesses may submit digital coupons by manually entering coupon data, by permitting the coupon system to search a business coupon database to find coupons to add to the central coupon database, or by automatically entering digital coupons using a third party website.

13. The method according to claim 9 wherein the user account allows the user to browse, organize, view, delete, share and redeem their digital coupons using platforms such as websites, applications, mobile devices, wearable devices, home entertainment systems, embedded systems and personal data storage devices.

14. The method according to claim 9 wherein redemption of the digital coupon(s) includes presenting a unique identifier that is associated with the user to a cashier, said unique identifier providing the cashier access to the user's coupon database.

15. A computing system for collecting, storing, distributing and tracking digital coupons, said system comprising:
an interface for a plurality of businesses to submit digital coupons to a central coupon database of an application programming interface of the computing system;
an interface of the computing system for consumers to create a user account with a user coupon database, wherein the user is able to browse coupons in the central coupon database and add selected coupons from the central coupon database to the user coupon database, said selected coupons being available for redemption after being added to the user coupon database; and
a performance tracking database that stores information about coupons that are selected and redeemed users of the computing system.

16. The system according to claim 15 wherein the plurality of businesses include businesses and manufacturers.

17. The system according to claim 15 wherein the plurality of businesses are provided with a partner ID that allows the one or more businesses to submit digital coupons.

18. The system according to claim 15 wherein the one or more businesses may submit digital coupons by manually entering coupon data, by permitting the coupon system to search a business coupon database to find coupons to add to the central coupon database, or by automatically entering digital coupons using a third party website.

19. The system according to claim 15 wherein the user account allows the user to browse, organize, view, delete, share and redeem their digital coupons using platforms such as websites, applications, mobile devices, wearable devices, home entertainment systems, embedded systems and personal data storage devices.

20. The system according to claim 15 wherein redemption of the digital coupon(s) includes presenting a unique identifier that is associated with the user to a cashier, said unique identifier providing the cashier access to the user's coupon database.
